(19) United States
(12) Patent Application Publication
(10) Pub. No.: US 2012/0310851 A1
(43) Pub. Date: Dec. 6, 2012

(54) System and method for online employment opportunities

(76) Inventor: Kimberly T. Klos, Carlsbad, CA (US)

(21) Appl. No.: 13/506,489

(22) Filed: Apr. 23, 2012

Related U.S. Application Data
(60) Provisional application No. 61/517,522, filed on Apr. 21, 2011.

(51) Int. Cl. G06Q 10/06

(52) U.S. Cl. 705/321

(57) ABSTRACT

A method and system of providing an on line employment opportunity to job seekers and employee seekers is described. The method includes consideration from the employee seeker to the job seeker in exchange for viewing access to the job seekers credentials and identifying information. The method further reduces the amount of effort for employee seekers and job seekers to identify each other's compatible preferences by categorizing credentials into levels of data, which can be managed within the system.

### CROSS-REFERENCE TO RELATED APPLICATIONS

This application claims the benefit of provisional patent application Ser. No. 61/517,522, filed 2011 Apr. 21 by the present inventor.

### FEDERALLY SPONSORED RESEARCH

Not Applicable.

### SEQUENCE LISTING OR PROGRAM

Not Applicable.

### BACKGROUND

1. The Field of the Disclosure

The present disclosure is directed to a system and method for online employment opportunities. In particular, the disclosure is directed to facilitating employment opportunity between employers and candidates by providing a system and method for posting and searching candidate credentials while providing consideration to job seekers.

2. Description of the Related Art

Job search engines are used to communicate important information about and between the job seeker (the resume) and the employee seeker (the job description) in hopes to find a proper fit of employment. However, because of the diverse job requirements of employers, and job experiences from job seekers, the extreme amounts of diverse data become overwhelming to manage, categorize, and sift through making the search arduous and frivolous. Job search engines have helped in managing and communicating the data. Ideally, the management and communication of the data matches the proper employer with the proper job seeker. Although some search engines provide incentives for the job seekers as U.S. Pat. No. 7,505,919 describes signing bonus and weekly prizes based on being hired; none provide consideration to the job seeker for continuing to look for work. Providing consideration to a job seeker on a continuing basis would be difficult for current search engines and databases because of how the information is presented.

Current job search engines and on line employment opportunities address the management of data in the form of a resume, which lists job seeker information such as identity, employment history, and skills in the form of a resume. The information is viewed on one resume once the employer has searched by key words or some other kind of smaller data set. Although key words help narrow the vast number of job seekers to a smaller lot or group whom best match a key word, there is still the extensive time to read through each resume before knowing if there are any matches within the returned list of job seeker profiles. Because of the considerable amount of time it takes to sift through profiles, employers have come to rely on headhunters and temporary agencies to do the sifting through, which in turn, increases the cost of finding an appropriate candidate.

The present disclosure reduces the amount of time it takes to identify the best match between employee seeker and job seeker, potentially eliminating the need for third entity such as headhunters and temporary agencies to do the sifting through of information, which in turn provides consideration to the job seeker on a continuous basis.

### SUMMARY OF THE DISCLOSURE

The present disclosure is directed to a system and method for online employment opportunities. In particular, the disclosure is directed to facilitating employment opportunity between employers and candidates by substituting the resume as a means of conveying valuable data, to a format displaying values and attributes of the job seeker as well as providing a profit based system for the job seeker.

By simplifying and reducing the amount of data initially into a simple format which identifies and narrows the volume of job seekers to only those which match the job description. Once the numbers of candidates are narrowed to a few manageable individuals, further credentials can be released at consecutive levels. As employers wish to view more details at these levels, the job seeker receives consideration.

Although job search engines require and expect job seekers to provide detailed information about their employment history, confidential identity information, and to fit into a standard resume format designed to extract information into databases in hopes of matching large and diverse amounts of data between employee seekers and job seekers, the resume format is too broad and requires too much sifting through of information. The present disclosure categorizes the most important credentials first, secondary credentials second, and so on.

### BRIEF DESCRIPTION OF THE DRAWINGS

The features and advantages of the disclosure become apparent when viewing the exemplary illustrations presented in that vast volumes of information can be ascertained in a short amount of time from a simpler format display, replacing traditional resume formats, and viewing credentials in connection with the accompanying drawings:

FIG. 1 is a flowchart outlining an exemplary system and method for creating profiles and searches by job seekers and employee seekers;

FIG. 2 is an illustrative view of an exemplary format display of job seeker credentials regarding software a job seeker has used;

FIG. 3 is an illustrative view of an exemplary format display of job seeker credentials regarding process' a job seeker has worked with;

FIG. 4 is an illustrative view of an exemplary format display of job seeker credentials regarding materials a job seeker has worked with;

FIG. 5 is an illustrative view of an exemplary format display of job seeker credentials regarding the titles a job seeker has held.

FIG. 6 is an exemplary cash flow chart displaying the consideration to job seekers.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method processes.

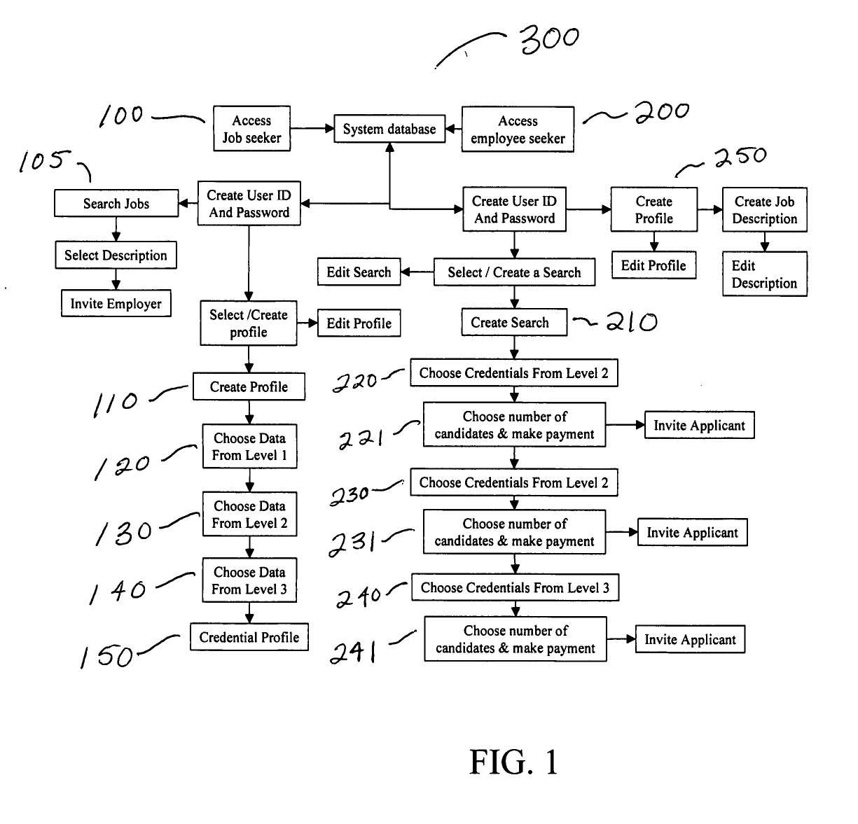

Referring to FIG. 1, there is shown an exemplary flowchart comprising a system 300 in accordance with the principles of this disclosure. System 300 may be a database management system and may be implemented on the Internet. System 300 may comprise method 100 for collecting and managing data. The method 100 may be used to access System 300 and perform searches 105. Alternatively, method 100 may be used to access System 300 and create a profile 110.

Still referring to FIG. 1, The method 100 in the exemplary flowchart may comprise a first level 120 for selecting data, a second level 130 for selecting data, and a third level 140 for selecting data. Alternatively, the method 100 may further comprise a plurality of levels for selecting data.

The method 100 in the exemplary flowchart may comprise a first level 120 for creating data, a second level 130 for creating data, and a third level 140 for creating data. Alternatively, the method 100 may further comprise a plurality of levels for creating data.

The method 100 in the exemplary flowchart may comprise a first level 120 for editing data, a second level 130 for editing data, and a third level 140 for editing data. Alternatively, the method 100 may further comprise a plurality of levels for editing data.

Still referring to FIG. 1, System 300 in the exemplary flowchart may further comprise method 200 for collecting and managing data. The method 200 may be used to access System 300 and create a profile 250. Alternatively, the method 200 may be used to access System 300 and perform searches 210.

Still referring to FIG. 1, The method 200 in the exemplary flowchart may comprise a first level 220 for selecting data, a second level 230 for selecting data, and a third level 240 for selecting data. Alternatively, the method 200 may further comprise a plurality of levels for selecting data.

The method 200 in the exemplary flowchart may comprise a first level 220 for creating data, a second level 230 for creating data, and a third level 240 for creating data. Alternatively, the method 200 may further comprise a plurality of levels for creating data.

The method 200 in the exemplary flowchart may comprise a first level 220 for editing data, a second level 230 for editing data, and a third level 240 for editing data. Alternatively, the method 200 may further comprise a plurality of levels for editing data.

Still referring to FIG. 1, the system 300 may further comprise a payment method. The search method 210 may comprise the payment steps 221, 231, 241. The search method 210 may further comprise a plurality of payment steps.

The payment method 221 may comprise from the number of data selected from the first level 220 data. Payment method 221 may further comprise consideration to the candidates selected from the search in first level 220 data.

The payment method 231 may comprise from the number of data selected from the second level 230 data. Payment method 231 may further comprise consideration to the candidates selected from the search in second level 230 data.

The payment method 241 may comprise from the number of data selected from the third level 240 data. Payment method 241 may further comprise consideration to the candidates selected from the search in third level 240 data.

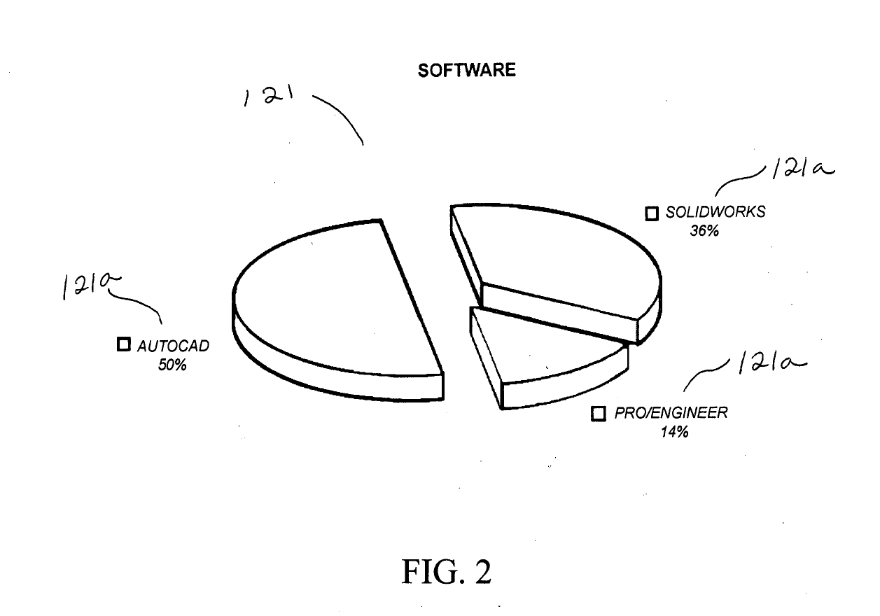

Now referring to FIG. 2, there is an exemplary illustration of data 121 collected from first level data 120 shown in FIG. 1 illustrative flowchart. The data 121 comprises data collected 121a. The data 121 may further comprise a plurality of data collected.

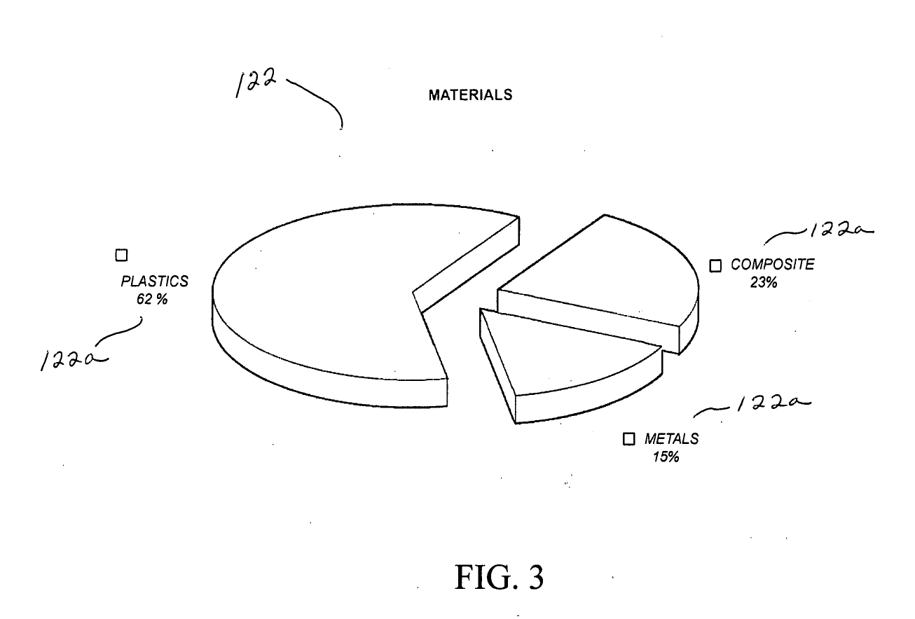

Now referring to FIG. 3, there is an exemplary illustration of data 122 collected from first level data 120 shown in FIG. 1 illustrative flowchart. The data 122 comprises data collected 122a. The data 122 may further comprise a plurality of data collected.

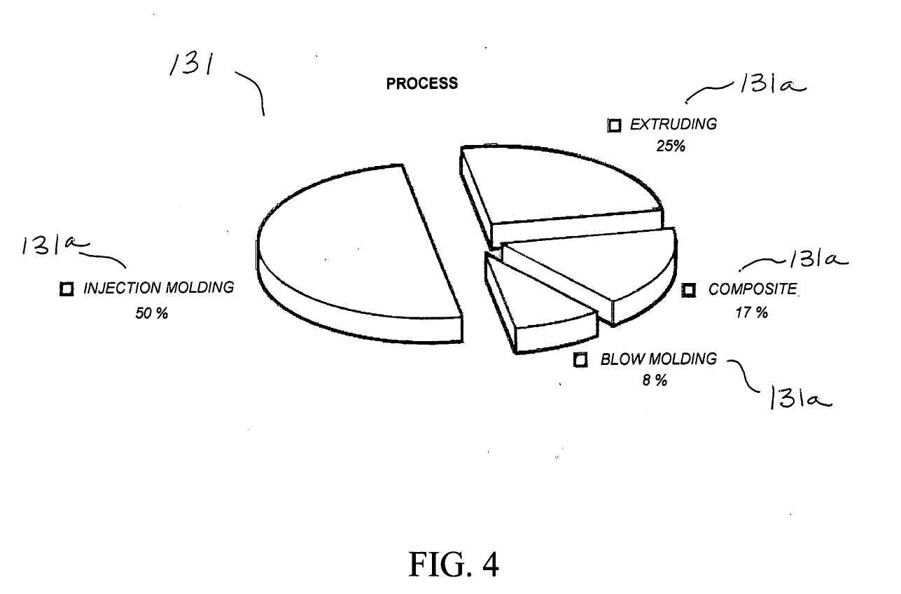

Now referring to FIG. 4, there is an exemplary illustration of data 131 collected from second level data 130 shown in FIG. 1 illustrative flowchart. The data 131 comprises data collected 131a. The data 131 may further comprise a plurality of data collected.

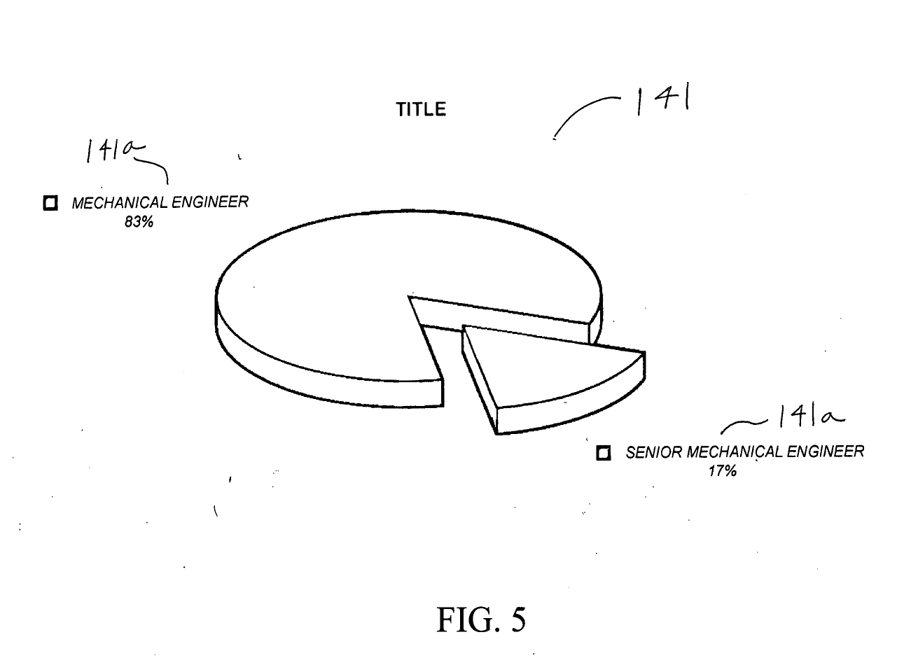

Now referring to FIG. 5, there is an exemplary illustration of data 141 collected from first level data 140 shown in FIG. 1 illustrative flowchart. The data 141 comprises data collected 141a. The data 141 may further comprise a plurality of data collected.

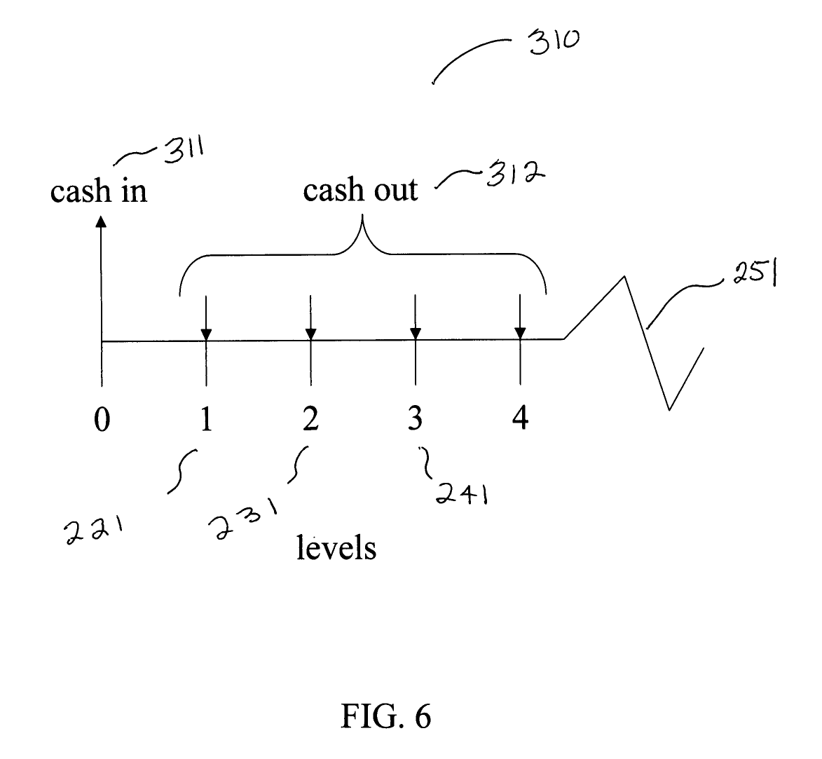

Now referring to FIG. 6, there is an exemplary cash flow diagram 310. System 300 shown in FIG. 1 may further comprise a payment method including consideration to the job seeker for each level of data an employee seeker views. The consideration may be a percentage of cash in 311.

Still referring to FIG. 6, the cash in 311 from payment of the employee seeker provides cash out 312 to the job seeker each time the employee seeker chooses to view a job seeker's profile in first level 221. At the first level 221, a percentage of cash in 311 of the employee seekers payment is distributed to the job seeker.

Still referring to FIG. 6, the cash in 311 from payment of the employee seeker provides cash out 312 to the job seeker each time the employee seeker chooses to view a job seeker's profile in second level 231. At the second level of 231, a percentage of cash in 311 of the employee seekers payment is distributed to the job seeker.

Still referring to FIG. 6, the cash in 311 from payment of the employee seeker provides cash out 312 to the job seeker each time the employee seeker chooses to view a job seeker's profile in third level 241. At the second level of 241, a percentage of cash in 311 of the employee seekers payment is distributed to the job seeker.

Still referring to FIG. 6, the cash in 311 from payment of the employee seeker provides cash out 312 to the job seeker each time the employee seeker chooses to view a job seeker's profile in a plurality of levels 251. At any level 251, a percentage of cash in 311 of the employee seekers payment is distributed to the job seeker.

What is claimed is:

1. A method for placing job seekers into jobs comprising:
an employment placement service wherein consideration is provided for the job seeker, said consideration is provided each time an employee seeker views a job seeker level of credentials.

2. The method of claim 1, wherein a job seeker creates a profile.

3. The method of claim 2, wherein the job seeker chooses at least one credential.

4. The method of claim 3, wherein at least one job seeker credential is listed in at least one level of data.

5. The method of claim 1, wherein an employee seeker creates a profile.

6. The method of claim 4, wherein an employee seeker pays to view at least one job seeker credential.
